(19) United States
(12) Patent Application Publication
(10) Pub. No.: US 2013/0158751 A1
(43) Pub. Date: Jun. 20, 2013

(54) Stand Alone Aircraft Flight Data Transmitter

(71) Applicants: Bradley D. Cornell, Lake Stevens, WA (US); Gordon Robert Andrew Sandell, Bothell, WA (US); Stephen Y. Lee, Shoreline, WA (US)

(72) Inventors: Bradley D. Cornell, Lake Stevens, WA (US); Gordon Robert Andrew Sandell, Bothell, WA (US); Stephen Y. Lee, Shoreline, WA (US)

(73) Assignee: THE BOEING COMPANY, Chicago, IL (US)

(21) Appl. No.: 13/327,023

(22) Filed: Dec. 15, 2011

(51) Int. Cl. G01M 17/00; G06F 19/00

(52) U.S. Cl. 701/14

(57) ABSTRACT

A method and apparatus for transmitting data. An aircraft data transmission system comprises an aircraft flight data transmitter. The aircraft flight data transmitter is configured to be connected to a connector for an on-board flight data recorder system for an aircraft. The aircraft flight data transmitter is further configured to receive data generated by sensors in the aircraft from the on-board flight data recorder system. The aircraft flight data transmitter is further configured to determine whether an undesired condition is present in the aircraft using the data. The aircraft flight data transmitter is further configured to initiate sending of at least a portion of the data received from the on-board flight data recorder system over a wireless communications link in response to a determination that the undesired condition is present in the aircraft.

### CROSS-REFERENCE TO RELATED APPLICATION

This application is related to patent application U.S. Ser. No. 12/623,909, filed Nov. 23, 2009, entitled “Automatic Emergency Reporting”, which is incorporated herein by reference.

### BACKGROUND INFORMATION

1. Field

The present disclosure relates generally to aircraft and, in particular, to transmitting data from aircraft. Still more particularly, the present disclosure relates to a method and apparatus for transmitting data from an aircraft when an undesired condition is present for the aircraft.

2. Background

Aircraft have many sensors that generate data used to operate the aircraft. For example, sensors may provide data about airspeed, temperature, pressure, location, control surface positions, cabin pressure, and other types of data. This data is used by the operators of the aircraft as well as by different systems in the aircraft during flight.

Further, some or all of this data also may be stored in on-board flight data recorder systems. These on-board flight data recorder systems may include flight data recorders, voice recorders, and other suitable types of systems. Additionally, these recorders also may record audio data from microphone sensors in the aircraft. These recorders may be in separate units or combined into a single unit. These types of recorders may provide data needed to analyze an undesired condition that may occur in an aircraft. This information may be especially useful if the aircraft has an unintended encounter with terrain.

When an unintended encounter with terrain occurs, responders to this event may be faced with a challenge in locating the aircraft. For example, responders may attempt to locate the aircraft from existing air traffic control location data. When the aircraft is located, the responders may begin the investigation by removing the on-board flight data recorder system from the aircraft. The data stored in the on-board flight data recorder system may then be used to help determine the cause of the unintended encounter with the terrain.

Prior to analyzing the data recorded by the on-board flight data recorder system, very little may be known about the cause of the unintended encounter with terrain. These on-board flight data recorder systems often have transmitters that are configured to transmit signals to aide in locating the on-board flight data recorder system.

However, in some cases, locating the aircraft may be more difficult than desired. For example, if an aircraft has an unintended encounter with terrain, such as an ocean during a storm, it may be difficult to locate the aircraft. If the aircraft has an unintended encounter with terrain in the form of an ocean, the aircraft may reach the ocean floor and the transmitters may be unable to transmit signals detectable by responders. Further, the transmitters may only operate for a limited amount of time prior to running out of power. If the transmitters run out of power prior to the aircraft being located, the aircraft may be even more difficult to locate on the ocean floor.

Therefore, it would be desirable to have a method and apparatus that takes into account at least some of the issues discussed above as well as possibly other issues.

### SUMMARY

In one illustrative embodiment, an aircraft data transmission system comprises an aircraft flight data transmitter. The aircraft flight data transmitter is configured to be connected to a connector for an on-board flight data recorder system for an aircraft. The aircraft flight data transmitter is further configured to receive data generated by sensors in the aircraft from the on-board flight data recorder system. The aircraft flight data transmitter is further configured to determine whether an undesired condition is present in the aircraft using the data. The aircraft flight data transmitter is further configured to initiate sending of at least a portion of the data received from the on-board flight data recorder system over a wireless communications link in response to a determination that the undesired condition is present in the aircraft.

In another illustrative embodiment, a method for transmitting data is present. The data generated by sensors in an aircraft is received from an on-board flight data recorder system at an aircraft flight data transmitter connected to a connector for the on-board flight data recorder system. A determination is made as to whether an undesired condition is present in the aircraft using the data. Sending of at least a portion of the data received from the on-board flight data recorder system over a wireless communications link is initiated in response to a determination that the undesired condition is present in the aircraft.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of an illustrative embodiment of the present disclosure when read in conjunction with the accompanying drawings, wherein:

FIG. 1 is an illustration of a block diagram of an aircraft information environment in accordance with an illustrative embodiment;

FIG. 2 is an illustration of a block diagram of components in an aircraft data transmitter in accordance with an illustrative embodiment;

FIG. 3 is an illustration of an aircraft flight data transmitter connected to an on-board flight data recorder system in accordance with an illustrative embodiment;

FIG. 4 is a diagram of an aircraft in which an illustrative embodiment may be implemented;

FIG. 5 is an illustration of a flowchart of a process for transmitting data in accordance with an illustrative embodiment;

FIG. 6 is an illustration of a flowchart of a process for determining whether an undesired condition is present in an aircraft in accordance with an illustrative embodiment;

FIG. 7 is an illustration of a data processing system in accordance with an illustrative embodiment;

FIG. 8 is an illustration of an aircraft manufacturing and service method in accordance with an illustrative embodiment; and

FIG. 9 is an illustration of an aircraft in which an illustrative embodiment may be implemented.

### DETAILED DESCRIPTION

The different illustrative embodiments recognize and take into account a number of different considerations. For example, the different illustrative embodiments recognize and take into account that it may be desirable to obtain data from an aircraft prior to locating the aircraft. The different illustrative embodiments recognize and take into account that with data obtained prior to and during the undesired condition for the aircraft, locating the aircraft may be easier to perform than without the data. Further, having the data obtained prior to and during the occurrence of the undesired condition may also allow for analysis of the unintended encounter with terrain to begin even before the on-board flight data recorder system for the aircraft is found.

In one or more illustrative embodiments, a method and apparatus is present for sending data from an aircraft. In one illustrative embodiment, an aircraft flight data transmitter is configured to be connected to an on-board flight data recorder system for an aircraft. The aircraft flight data transmitter is configured to receive data generated by sensors in the aircraft from the on-board flight data recorder system. Further, the aircraft flight data transmitter is configured to determine whether an undesired condition is present in the aircraft using the data and to initiate sending at least a portion of the data received from the on-board flight data recorder system over a wireless communications link in response to a determination that the undesired condition is present in the aircraft.

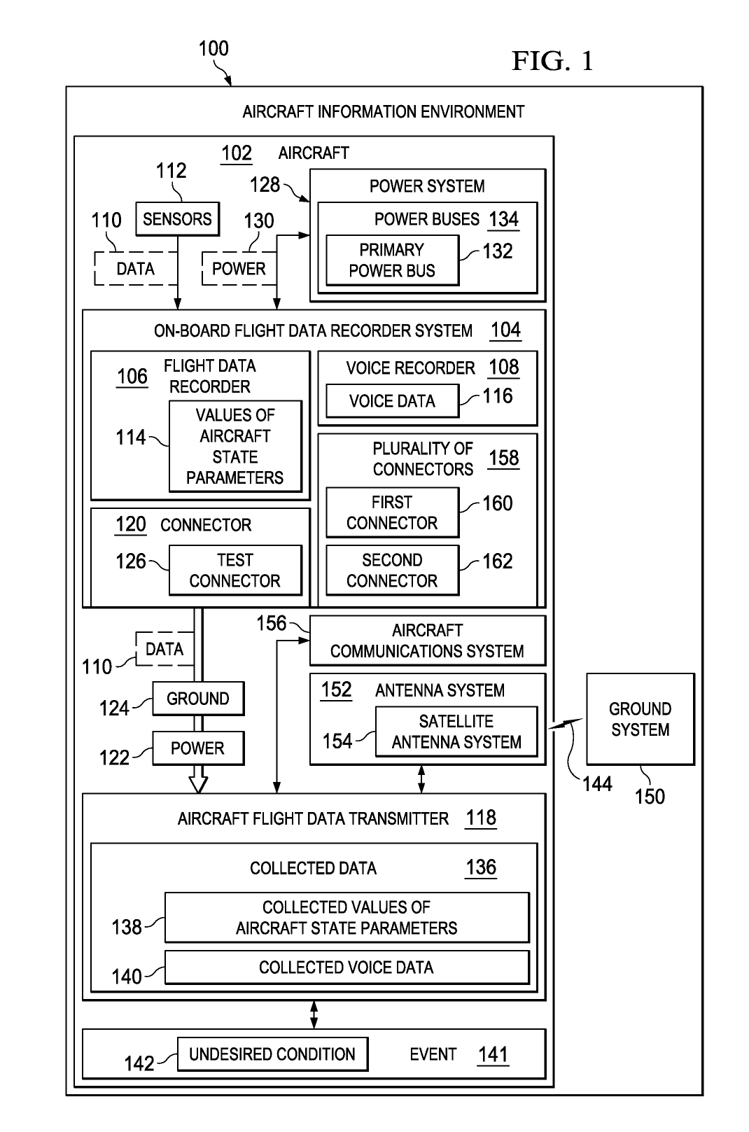

With reference now to the figures and, in particular, with reference to FIG. 1, an illustration of a block diagram of an aircraft information environment 100 is depicted in accordance with an illustrative embodiment. As depicted, the aircraft information environment 100 includes an aircraft 102. The aircraft 102 has an on-board flight data recorder system 104. The on-board flight data recorder system 104 may include at least one of a flight data recorder 106, a voice recorder 108, and other suitable types of recorders.

As used herein, the phrase “at least one of”, when used with a list of items, means different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C.

On-board flight data recorder system 104 receives data 110 from the sensors 112. For example, the flight data recorder 106 in on-board flight data recorder system 104 is configured to receive the data 110 from sensors 112 in the aircraft 102. The data 110 received by flight data recorder 106 from the sensors 112 may take the form of values of aircraft state parameters 114.

The values of aircraft state parameters 114 may be for aircraft state parameters comprising at least one of rate of descent, altitude, pitch angle, bank angle, pitch rate, amount of fuel, position, landing gear status, autopilot status, engine speed, pressure, oil temperature, air temperature, control surface configuration, wind speed, direction, and other suitable parameters for which the values of aircraft state parameters 114 may be received from sensors 112. In some illustrative examples, the values of aircraft state parameters 114 may be obtained from the data 110 received from sensors 112. The flight data recorder 106 is configured to store the data 110.

Additionally, the voice recorder 108 may receive voice data 116 in the data 110 from microphones in the sensors 112. The voice data 116 may be communications by the flight crew with a ground station, ambient sounds in the cockpit, communications between the crew members, and other suitable types of data.

In these illustrative examples, the data 110 received by the on-board flight data recorder system 104 is stored in the on-board flight data recorder system 104.

The data 110 is stored in the on-board flight data recorder system 104 in case an unintended encounter with terrain occurs. If such an event occurs, the on-board flight data recorder system 104 may be retrieved and the data 110 stored in the on-board flight data recorder system 104 may be analyzed to determine a cause of the unintended encounter with terrain by the aircraft 102.

In these illustrative examples, the different illustrative embodiments recognize and take into account that it may be desirable to transmit at least a portion of the data 110 prior to the on-board flight data recorder system 104 being retrieved in the event that an unintended encounter with terrain occurs.

As depicted, an aircraft flight data transmitter 118 is connected to the on-board flight data recorder system 104. In these illustrative examples, the aircraft flight data transmitter 118 is connected to the on-board flight data recorder system 104 at a connector 120 for the on-board flight data recorder system 104. In these illustrative examples, the connector 120 provides data 110 and power 122. The connector 120 also may provide ground 124 to aircraft flight data transmitter 118.

In these illustrative examples, the connector 120 is an existing connector for the on-board flight data recorder system 104. In other words, the connector 120 is a connector that is physically located on the on-board flight data recorder system 104. In particular, the connector 120 may take the form of a test connector 126. The test connector 126 is present for use in connecting test equipment to the on-board flight data recorder system 104 for testing. The aircraft flight data transmitter 118 may use this test connector 126 rather than requiring a new connector or some other type of connection. Of course, the connector 120 may take other forms, depending on the implementation. For example, the connector 120 may be selected from one of a universal serial bus (USB) connector, a network interface card (NIC) connector, a serial port, an IEEE 1394 interface, and other suitable types of connectors.

In these illustrative examples, a power system 128 is configured to provide power 130 to the on-board flight data recorder system 104. In turn, the on-board flight data recorder system 104 may use the power 130 received from the power system 128 to provide power 122 to the aircraft flight data transmitter 118 through the connector 120 for the on-board flight data recorder system 104.

In these illustrative examples, the on-board flight data recorder system 104 receives the power 130 through a connection to a primary power bus 132 in the power buses 134 in power system 128. The power buses 134 may have different levels of priority. The primary power bus 132 has a highest priority in terms of power distribution in the power buses 134. In other words, another one of the power buses 134 may lose power before the primary power bus 132 if insufficient amounts of power 130 are available from the power system 128.

As a result, the primary power bus 132 may be the last bus to lose power in the power system 128. Thus, the aircraft flight data transmitter 118 may be one of the last devices to lose power because the flight data transmitter 118 receives the power 122 from the on-board flight data recorder system 104, which receives the power 130 through the primary power bus 132.

In these illustrative examples, locating the primary power bus 132 for use by the aircraft flight data transmitter 118 is unnecessary when aircraft flight data transmitter 118 is connected to the connector 120. Instead, the connection to the connector 120 on the on-board flight data recorder system 104 provides power 122 which is a portion of power 130 received from the primary power bus 132 in the power system 128 on the aircraft 102.

In these illustrative examples, the data 110 about the aircraft 102 received from the on-board flight data recorder system 104 through the connector 120 by the aircraft flight data transmitter 118 may be stored as collected data 136. The collected data 136 may be a portion or all of the data 110 received from the on-board flight data recorder system 104.

For example, the aircraft flight data transmitter 118 may store the data 110 about the aircraft 102 received from the on-board flight data recorder system 104 as collected data 136 temporarily. More specifically, the collected data 136 may be stored for a period of time. After the period of time is expired, a portion of the collected data 136 may be deleted or erased. In other illustrative examples, the length of time that portions of the collected data 136 are stored may depend on the amount of space used to store the collected data 136.

For example, if 1 megabyte (MB) of storage space is allocated for the collected data 136 and new amounts of the data 110 are received that exceed 1 MB, stored portions of the collected data 136 may be deleted. The deletion may be made on a first in-first out basis in these illustrative examples.

In these illustrative examples, the values of aircraft state parameters 114 form collected values of aircraft state parameters 138 in the collected data 136 stored in the aircraft flight data transmitter 118. The voice data 116 in the data 110 forms collected voice data 140 in the collected data 136 stored in the aircraft flight data transmitter 118.

In the illustrative examples, the aircraft flight data transmitter 118 may transmit at least a portion of the collected data 136 in response to an event 141. The event 141 may take various forms. For example, the event 141 may be an undesired condition 142 for the aircraft 102.

In these illustrative examples, the aircraft flight data transmitter 118 is configured to determine whether an undesired condition 142 in the aircraft 102 is present in the aircraft 102 using the data 110 received from the on-board flight data recorder system 104. More specifically, the aircraft flight data transmitter 118 determines whether the undesired condition 142 is present using the collected data 136 collected from the data 110 received from the on-board flight data recorder system 104. In particular, the collected values of aircraft state parameters 138 may be used to determine whether the undesired condition 142 is present.

In these illustrative examples, the aircraft flight data transmitter 118 initiates sending at least a portion of the data 110 received from the on-board flight data recorder system 104 over a wireless communications link 144 in response a determination that the undesired condition 142 is present in the aircraft 102. For example, the portion of the data 110 may be about 30 seconds of the collected voice data 140 prior to the undesired condition 142 in the aircraft 102, and about 30 seconds of the collected voice data 140 after the undesired condition 142 occurs in the aircraft 102.

Additionally, the portion of the data 110 sent may include location data for the aircraft 102 for about 20 seconds prior to the undesired condition 142 occurring in the aircraft 102, and for about 20 seconds after the undesired condition 142 occurs in the aircraft 102. In other words, the location data may include a number of locations for the aircraft 102 at different times.

This location data for the 40 seconds may provide an indication of not only the location of the aircraft 102 but also the trajectory of the aircraft 102. Of course, other periods of time may be used, depending on the particular implementation as well as other types of data. For example, the collected values of aircraft state parameters 138 also may include the speed and attitude of the aircraft 102 in addition to the location data.

The location data may include at least one of a latitude, a longitude, an altitude, and the time at which the latitude, longitude, and altitude for the location of the aircraft 102 were identified. When a number of locations are present in the location data, a trajectory of the aircraft 102 may be identified from the location data.

In some illustrative examples, the location data may include additional information for a particular location. For example, the additional location in the location data may also include at least one of a heading, a track, an airspeed, a mach number, a descent rate, pitch, bank, and other suitable information. The trajectory may be identified as a path that the aircraft 102 followed through the different locations. In other illustrative examples, the trajectory may be identified as a vector for the aircraft 102. Additionally, the orientation for the aircraft may be identified using the location information.

In yet other illustrative examples, the aircraft flight data transmitter 118 may continue to transmit the collected data 136 as long as the aircraft flight data transmitter 118 has power 122 and receives the data 110. In this particular example, the aircraft flight data transmitter 118 may continue to transmit the collected data 136 up to and even after an unintended encounter with terrain. The collected data 136 also may be transmitted when the unintended encounter is with an object. The object may be another mobile platform, such as an aircraft, a bird, a missile, or some other type of mobile platform.

In these illustrative examples, the wireless communications link 144 is a link to a ground system 150. The ground system 150 may be, for example, without limitation, an air traffic control tower, an airline dispatching station, an aircraft manufacturer, or some other suitable ground system.

In these illustrative examples, the aircraft flight data transmitter 118 may establish the wireless communications link 144 with the ground system 150 through an antenna system 152 for the aircraft 102. The antenna system 152 has a number of antennas in these depicted examples. In particular, the antenna system 152 may take the form of a satellite antenna system 154. Of course, the antenna system 152 may take other forms, depending on the particular implementation. For example, radio frequency antennas or other types of antennas may be used in the antenna system 152.

In these illustrative examples, the aircraft flight data transmitter 118 is connected to the antenna system 152. In particular, the aircraft flight data transmitter 118 also provides power 122 for the antenna system 152. The antenna system 152 is configured to operate from the power 122 provided through the aircraft flight data transmitter 118 in these illustrative examples.

As another illustrative example, the aircraft flight data transmitter 118 also may be connected to the aircraft communications system 156 for the aircraft 102. The aircraft communications system 156 is the system normally used for voice and data communications in the aircraft 102. The aircraft communications system 156 may be connected to other power buses 134 other than the primary power bus 132 in these illustrative examples. The aircraft flight data transmitter 118 may initiate communications using the aircraft communications system 156 in addition to sending at least a portion of the collected values of aircraft state parameters 138 over the antenna system 152. In this manner, the aircraft flight data transmitter 118 may transmit at least a portion of the collected data 136 over the wireless communications link 144 to the ground system 150 in response to a determination that the undesired condition 142 is present in the aircraft 102.

Consequently, the aircraft 102 and the on-board flight data recorder system 104 may be more quickly located, especially when the collected data 136 includes the location data about the aircraft 102. The location data may be, for example, without limitation, coordinates of the aircraft 102. These coordinates may be, for example, latitude, longitude, and altitude. Further, with at least a portion of the collected data 136, an analysis of the undesired condition 142 and the unintended encounter with terrain may begin more quickly without having the on-board flight data recorder system 104.

Also, the illustrative embodiments reduce the time and effort normally needed by adding transmitters to an aircraft to transmit the data 110 in response to the undesired condition 142 that may result in an unintended encounter with terrain. Locating the primary power bus 132 is unnecessary with the connection to the connector 120 in the on-board flight data recorder system 104. As a result, loss of power 122 to the aircraft flight data transmitter 118 may be reduced.

The illustration of the aircraft information environment 100 in FIG. 1 is not meant to imply physical or architectural limitations to the manner in which an illustrative embodiment may be implemented. Other components in addition to and/or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, the aircraft flight data transmitter 118 may be connected to a plurality of connectors 158 for the on-board flight data recorder system 104 instead of just the connector 120. For example, if the on-board flight data recorder system 104 comprises multiple units, then each unit may have a connector within the plurality of connectors 158. With this configuration, the aircraft flight data transmitter 118 may be connected to each of the plurality of connectors 158.

In yet another illustrative example, when the on-board flight data recorder system 104 includes the flight data recorder 106 and the voice recorder 108, these recorders may be implemented in a number of different ways. For example, the blocks for the flight data recorder 106 and the voice recorder 108 may be separate physical units. In another example, a single unit may combine functions from the flight data recorder 106 and the voice recorder 108. The single unit may take the form of a combined flight data and voice recorder.

In other words, the functional blocks illustrated for the flight data recorder 106 and the voice recorder 108 may be combined into a single block. This single block may be implemented as a single physical unit in the illustrative examples.

For example, the flight data recorder 106 may have a first connector 160 and the voice recorder 108 may have a second connector 162 when these two components are implemented as separate physical units. With this example, the aircraft flight data transmitter 118 is connected to both the first connector 160 and the second connector 162 in the plurality of connectors 158. In this example, at least one of the power 122 and the data 110 may be received through the first connector 160 and the second connector 162. As another illustrative example, at least a portion of the collected data 136 is sent over another wireless communications link to one or more other ground stations in addition to the ground system 150.

In the illustrative example, the connector 120 has been described as providing a direct connection to the on-board flight data recorder system 104. In other words, the aircraft flight data transmitter 118 is connected to the connector 120 in which the connector 120 does not include any intervening devices between the on-board flight data recorder system 104 and the aircraft flight data transmitter 118.

In still other illustrative examples, the connector 120 may provide an indirect connection between the on-board flight data recorder system 104 and the aircraft flight data transmitter 118. For example, the aircraft flight data transmitter 118 may be connected to a universal serial bus hub, which is, in turn, connected to the connector 120.

As yet another illustrative example, the event 141 may take other forms other than the undesired condition 142. For example, the event 141 may be a periodic event. In other words, the aircraft flight data transmitter 118 may transmit the collected data 136 periodically, such as every hour, every 30 minutes, or after other period of time.

In still other illustrative examples, the event 141 may be a non-periodic event. For example, the event 141 may be a phase of flight. In this particular example, the aircraft flight data transmitter 118 may transmit the collected data 136 after take-off, during descent, after landing, during taxiing, or in response to any other phase of flight for the aircraft 102.

The event 141 may also take the form of a user input. For example, the event 141 may transmit the collected data 136 in response to a crew member pushing a particular button. In one example, in the event of undesired actions by one or more people in the aircraft, a crew member may push a button or some other user input device in the aircraft 102 to transmit the collected voice data 140 and/or the collected values of aircraft state parameters 138. The undesired actions may be an attempted hijacking of the aircraft 102, undesirable external conditions, or some other undesired action. The undesirable external conditions may be, for example, without limitation, weather turbulence, and/or some other external conditions that are undesirable.

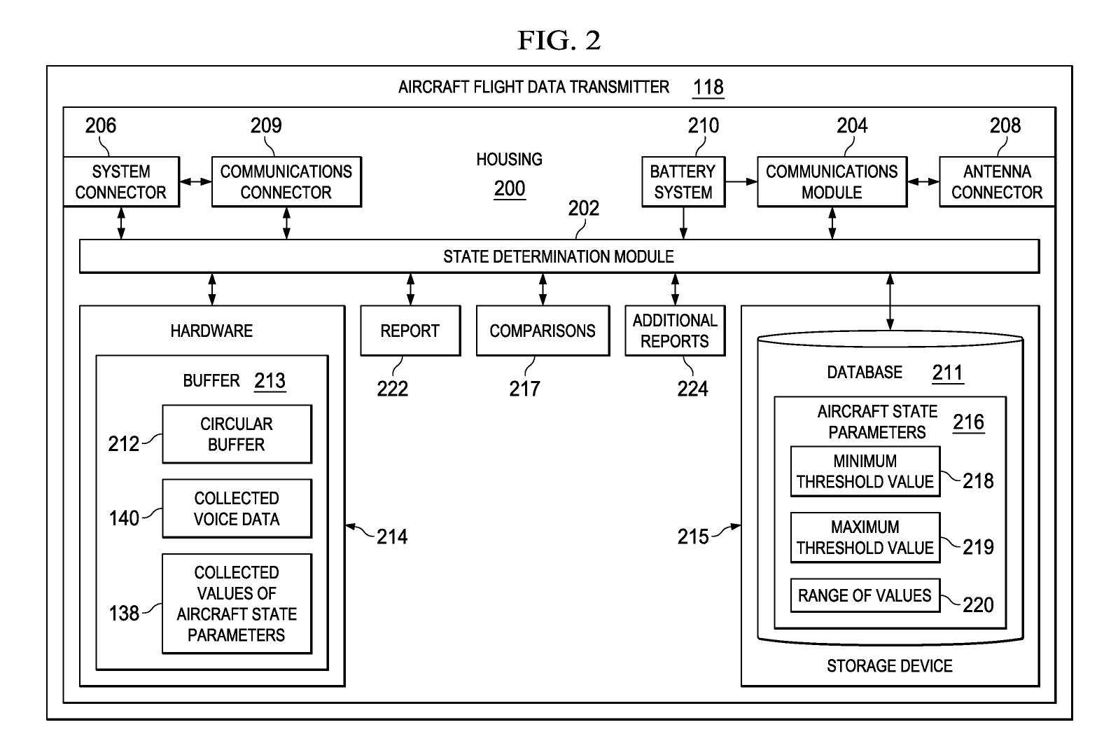

Turning now to FIG. 2, an illustration of a block diagram of components in the aircraft data transmitter 118 in FIG. 1 is depicted in accordance with an illustrative embodiment. In this illustrative example, the aircraft flight data transmitter 118 may comprise a housing 200 that holds a state determination module 202, a communications module 204, a system connector 206, an antenna connector 208, a communications connector 209, a battery system 210, a database 211, a buffer 213, and other suitable components.

As depicted, the system connector 206 may be connected to the connector 120 for the on-board flight data recorder system 104 in FIG. 1. The antenna connector 208 may be connected to the antenna system 152 in FIG. 1. The communications connector 209 is configured to be connected to the aircraft communications system 156 in FIG. 1.

In this illustrative example, the state determination module 202 and the communications module 204 may each be implemented using hardware, software, or a combination of the two. When software is used, the different operations performed by state determination module 202 and communications module 204 may be implemented in program code configured to be run on a processor unit. When hardware is employed to perform one or more of the operations implemented in state determination module 202 and communications module 204, the hardware may include circuits that operate to perform the operations in these modules.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. Additionally, the processes may be implemented in organic components integrated with inorganic components and/or may be comprised entirely of organic components excluding a human being.

In these illustrative examples, the collected values of aircraft state parameters 138 are stored in a buffer 213. Additionally, the collected voice data 140 is also stored in the buffer 213. As depicted, the buffer 213 is coupled to the state determination module 202. In these illustrative examples, the buffer 213 may be located in the state determination module 202 when the state determination module 202 includes hardware.

In these illustrative examples, the buffer 213 in the aircraft flight data transmitter 118 is an area of physical storage. This area of physical storage is typically used to hold data temporarily, such as collected data 136 prior to the collected data 136 being used or moved to another location.

The buffer 213 may be hardware 214 that is specifically designed to store data. In other illustrative examples, the buffer 213 may be implemented using software that allocates a portion of storage device 215 or other types of storage devices. In these illustrative examples, the buffer 213 may take various forms, such as, for example, a circular buffer 212.

In these illustrative examples, the state determination module 202 collects the data 110 from the on-board flight data recorder system 104 and stores the data 110 as collected values of aircraft state parameters 138 and collected voice data 140 in the buffer 213 within the aircraft flight data transmitter 118. The collected values of aircraft state parameters 138 may be collected at different intervals from the on-board flight data recorder system 104 or in real time, depending on the particular implementation. The collected voice data 140 is collected continuously in these illustrative examples.

As depicted, the state determination module 202 determines whether an undesired condition 142 is present using the collected values of aircraft state parameters 138. For example, the state determination module 202 compares the collected values of aircraft state parameters 138 with the normal values of aircraft state parameters 216 stored in the database 211.

As depicted, the database 211 is coupled to the state determination module 202. In these illustrative examples, the database 211 may be located in the state determination module 202 when the state determination module 202 is implementation in hardware 214. In other illustrative examples, the database 211 may be stored on a storage device 215 within the housing 200 of the aircraft flight data transmitter 118. The storage device 215 may be, for example, without limitation, a hard drive, a solid state drive, a random access memory, a non-volatile random access memory, and other suitable types of storage devices.

This comparison of the collected values of aircraft state parameters 138 stored in the buffer 213 to the normal values of the aircraft state parameters 216 stored in the database 211 is made by the state determination module 202 to determine whether a normal operation, anomalous operation, a normal condition, and/or an anomalous condition of the aircraft 102 is present. If anomalous operation and/or anomalous condition of the aircraft 102 is present, the undesired condition 142 is present for the aircraft 102. In these illustrative examples, the undesired condition 142 may not result in an unintended encounter with terrain by the aircraft 102.

The normal values of the aircraft state parameters 216 may indicate when normal operation and/or condition of the aircraft 102 is present. These normal values of aircraft state parameters 216 indicate acceptable values for the aircraft state parameters for normal operation and/or condition of the aircraft 102 in which an undesired condition 142 is absent.

If one or more of the collected values of aircraft state parameters 138 indicate the undesired condition 142 is absent in the aircraft 102, then the state determination module 202 may determine that the collected values of aircraft state parameters 138 do not need to be sent to the ground system 150. If one or more of the collected values of aircraft state parameters 138 indicates that the undesired condition 142 is present in the aircraft 102, then the state determination module 202 may determine that the collected values of aircraft state parameters 138, the collected voice data 140, or both should be sent to the ground system 150.

The normal values of the aircraft state parameters 216 may include various values for a variety of parameters associated with the operation and/or condition of the aircraft 102. For example, some of the collected values of aircraft state parameters 138 may indicate that the aircraft 102 is experiencing or about to experience an unintended encounter with terrain. For example, the collected values of aircraft state parameters 138 may include an unusually high rate of descent, a multiple engine-out condition, an airspeed exceeding velocity maximum operating or Mach maximum operating number by a given threshold, an airspeed below a given threshold, an amount below a given threshold, a cabin altitude above a given threshold, and other suitable values.

For example, the threshold for the airspeed may indicate a stall during flight of the aircraft 102. The remaining fuel below a selected threshold may indicate that the aircraft may no longer be able to stay in flight.

In some illustrative examples, the normal values of aircraft state parameters 216 may be adjusted by the flight crew on the aircraft 102, an airline operating the aircraft 102, a manufacturer, or some other entity. In some other illustrative examples, the normal values of aircraft state parameters 216 may be fixed and may not be adjustable. In still other illustrative examples, some of the comparisons 217 made between the collected values of aircraft state parameters 138 and the normal values of aircraft state parameters 216 may be activated or deactivated.

In this manner, the flight crew, an airline, a manufacturer, or some other entity may be able to select which of the collected values of aircraft state parameters 138 are compared to the normal values of aircraft state parameters 216 in identifying whether an undesired condition 142 is present for the aircraft 102. In other words, not all of the collected values of aircraft state parameters 138 need to be used to determine whether normal operation or anomalous operation of the aircraft 102 is occurring.

In these illustrative examples, the state determination module 202 may compare the collected values of aircraft state parameters 138 to the normal values of aircraft state parameters 216 for a given instance, multiple instances, and/or for a given period of time. The state determination module 202 may compare the collected values of aircraft state parameters 138 to the normal values of aircraft state parameters 216 at regular intervals, upon request, and/or upon some event.

In these illustrative examples, the normal values of aircraft state parameters 216 may include at least one of a minimum threshold value 218, a maximum threshold value 219, a range of values 220, and other suitable types of values. If one or more of the collected values of aircraft state parameters 138 are below the minimum threshold value 218, then the collected values of aircraft state parameters 138 indicate anomalous operation of the aircraft 102. With the maximum threshold value 219, if one or more of the collected values of aircraft state parameters 138 are above the maximum threshold value 219, then the collected values of aircraft state parameters 138 may also indicate anomalous operation of the aircraft 102.

The range of values 220 may indicate an acceptable range or unacceptable range for the collected values of aircraft state parameters 138. For example, when the range of values 220 is an acceptable range, if one or more of the collected values or aircraft state parameters 138 is inside of the range of values 220, then the collected values of aircraft state parameters 138 may indicate the undesired condition 142 in the aircraft 102. When the range of values 220 is an unacceptable range, if the collected values of aircraft state parameters 138 are within the range of values 220, then the undesired condition 142 may be present in the aircraft 102.

Further, multiple values in the collected values of aircraft state parameters 138 may be used to determine whether the undesired condition 142 is present for the aircraft 102. For example, multiple values from the collected values of aircraft state parameters 138 for an engine may be used to determine whether an engine is not operating as desired or has failed. For example, values may no longer be received from a control unit for an engine when the engine stops. The validity or absence of the value for that parameter may be considered a parameter for determining whether the engine is properly operating in the aircraft 102. In some cases, the value for a parameter may be absent because a device no longer generates a value for the parameter. In other cases, another device may be connected to the device that no longer generates the value and may generate an indication that the parameter is invalid.

In these illustrative examples, the collected values of aircraft state parameters 138 may provide a status or state rather than a numerical value. In still other illustrative examples, one or more of the minimum threshold value 218, the maximum threshold value 219, and the range of values 220 may be combined using Boolean Logic when determining whether the undesired condition 142 is present for the aircraft 102. In particular, by combining two or more of the normal values of aircraft state parameters 216 through Boolean Logic, simple as well as complex relationships between the normal values of aircraft state parameters 216 may be defined and identified by the state determination module 202.

When one or more of the collected values of aircraft state parameters 138 indicate that the undesired condition 142 for the aircraft 102 is not present, the state determination module 202 may continue receiving the data 110 to form the collected values of aircraft state parameters 138 and compare the collected values of aircraft state parameters 138 with the normal values of aircraft state parameters 216.

When one or more of the collected values of aircraft state parameters 138 indicate that the undesired condition 142 is present, then the state determination module 202 may initiate transmission of at least a portion of the data 110 stored as the collected values of aircraft state parameters 138. These collected values of aircraft state parameters 138 may be the most recent values that have been collected from receiving data 110 from the on-board flight data recorder system 104.

As depicted, the portion of the data 110 that is transmitted is at least the portion of the data 110 from at least one of before detecting the undesired condition 142 and after detecting the undesired condition 142 the data 110 is sent over the wireless communications link 144 in response to a determination that the undesired condition 142 is present in the aircraft 102. In other words, the portion of the data 110 may include some of the data 110 stored as collected values of aircraft state parameters 138 from before the undesired condition 142 was detected. These collected values of aircraft state parameters 138 may allow those investigating the undesired condition 142 to know what happened prior the undesired condition 142 being present and also may provide some insight into how the undesired condition 142 occurred. Depending on the amount of the collected data 136 transmitted, investigators may be able to determine how the undesired condition 142 occurred, what caused the undesired condition 142, and other information about the undesired condition 142 even if the on-board flight data recorder system 104 cannot be recovered at a later time, or if the on-board flight data recorder system 104 is unable to operate to provide information when recovered.

In these illustrative examples, the collected values of aircraft state parameters 138 that are transmitted may include location data. The location data for the aircraft 102 may aide in locating the aircraft 102 as well as recovery of the on-board flight data recorder system 104.

Further, a portion of the collected voice data 140 in the collected data 136 stored in the buffer 213 also may be transmitted. For example, the buffer 213 may hold about 40 seconds of voice data 116 received as collected voice data 140 at any given time.

In other illustrative examples, other amounts of collected voice data 140 may be stored in the buffer 213. For example, about 70 seconds, about 120 seconds, or some other amount of the collected voice data 140 may be stored. In other illustrative examples, the amount of voice data 116 stored may be measured in amount of storage space rather than amount of time.

As new portions of collected voice data 140 are received from the on-board flight data recorder system 104, older portions of the collected voice data 140 in the buffer 213 may be discarded. When the buffer 213 takes the form of the circular buffer 212, older portions of the collected voice data 140 are overwritten as newer portions of voice data 116 are received to form the collected voice data 140. In other illustrative examples, other amounts of collected voice data 140 may be retained within the buffer 213.

In these illustrative examples, this transmission of at least a portion of the collected values of aircraft state parameters 138 stored in the buffer 213 may be in the form of a report 222. The report 222 may include one or more of the collected values of aircraft state parameters 138 collected from the data 110 in a format for use by the ground system 150.

In these illustrative examples, the state determination module 202 controls the communications module 204 to transmit the report 222 containing at least a portion of the data 110 in the collected values of aircraft state parameters 138. This transmission of the report 222 is to the ground system 150 over the wireless communications link 144 established by the communications module 204 using the antenna system 152. The report 222 may contain binary data, text, or other suitable representation of the portion of the collected values of aircraft state parameters 138 included in the report 222.

In these illustrative examples, the communications module 204 may continue to transmit one or more additional reports 224 containing the collected values of aircraft state parameters 138 for some period of time. This transmission may occur until the undesired condition 142 is no longer present or when the wireless communications link 144 is terminated. Further, the transmission of the collected values of aircraft state parameters 138 may continue until the aircraft flight data transmitter 118 is no longer able to transmit the collected values of aircraft state parameters 138 or the transmissions are terminated by the aircraft crew, by the ground system 150, or by some other source.

In these illustrative examples, the state determination module 202 also may initiate additional communications with the ground system 150 in the aircraft communications system 156 in the aircraft 102. For example, the state determination module 202 initiates communications through aircraft communications system 156 using at least one of automatic dependent surveillance-contract, controller pilot data link communications, and other suitable communications. These other communications may be used by the state determination module 202 to initiate a distress signal or other communications.

The battery system 210 provides a back-up for the power 122 received through the test connector 126 in the on-board flight data recorder system 104. The battery system 210 may be one or more battery cells. The battery system 210 may be charged through the power 122 received from the on-board flight data recorder system 104. The battery system 210 may be used by the state determination module 202 and the communications module 204 in the event that the power 122 from the on-board flight data recorder system 104 is lost.

The illustration of components for the aircraft flight data transmitter 118 in FIG. 2 is not meant to imply physical or architectural limitations to the manner in which the aircraft flight data transmitter 118 may be implemented. In other illustrative examples, other components may be used in addition to and/or in place of the ones illustrated. Further, the blocks in FIG. 2 for the aircraft flight data transmitter 118 are presented to illustrate some functional components in the aircraft flight data transmitter 118. One or more of these blocks may be combined, divided, or combined and divided into different blocks when implemented in different illustrative embodiments.

For example, in some illustrative examples, the communications connector 209 may be omitted from the aircraft flight data transmitter 118. As another illustrative example, the battery system 210 also may be absent in some implementations of the aircraft flight data transmitter 118.

As another illustrative example, the buffer 213 may be omitted in some illustrative examples. Instead, the collected data 136 may be stored in the storage device 215 with the database 211. In still other illustrative examples, some of the collected data 136 may be stored in the buffer 213 while other portions of the collected data 136 may be stored in the storage device 215 with the database 211.

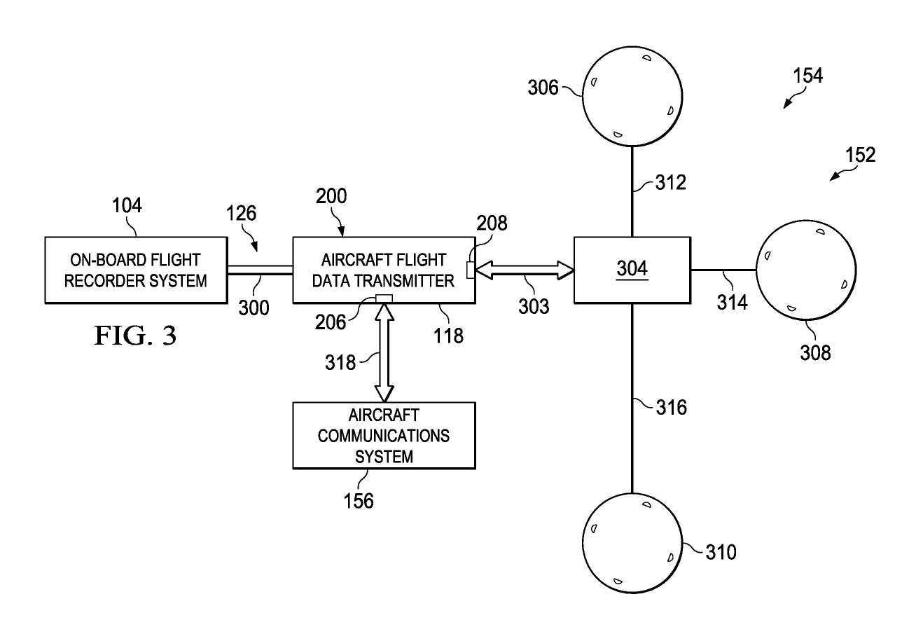

Turning next to FIG. 3, an illustration of the aircraft flight data transmitter 118 connected to the on-board flight data recorder system 104 is depicted in accordance with an illustrative embodiment. In this illustrative example, the aircraft flight data transmitter 118 is connected to the test connector 126 through the system connector 206. This connection between the test connector 126 and the system connector 206 is made using a cable 300. In this illustrative example, the cable 300 is configured to supply power 122 and data 110 to the aircraft flight data transmitter 118 from the on-board flight data recorder system 104. Additionally, the cable 300 also may provide ground 124 for the aircraft flight data transmitter 118. In this manner, the aircraft flight data transmitter 118 may receive both power 122 and data 110 from the on-board flight data recorder system 104.

As depicted, the aircraft flight data transmitter 118 is connected to the antenna system 152. This connection is made by connecting a cable 303 to the antenna connector 208 in the housing 200 of the aircraft flight data transmitter 118 and to the transmitter 304. This connection also provides power 122 for use in operating the antenna system 152.

In these illustrative examples, the antenna system 152 takes the form of a satellite antenna system 154. As depicted, the satellite antenna system 154 includes a transmitter 304 that is connected to a first satellite antenna 306, a second satellite antenna 308, and a third satellite antenna 310.

The transmitter 304 is connected to the first satellite antenna 306 by a first coaxial cable 312. The transmitter 304 is connected to the second satellite antenna 308 by a second coaxial cable 314. The transmitter 304 is connected to the third satellite antenna 310 by a third coaxial cable 316.

The locations of the first satellite antenna 306, the second satellite antenna 308, and the third satellite antenna 310 may be such that at least one of these satellite antennas has a view of the sky during operation of the aircraft 102. The positioning of these satellite antennas may be such that one of the satellite antennas has a view of the sky even when the aircraft 102 is inverted or upside down.

Additionally, the aircraft flight data transmitter 118 may be connected to the aircraft communications system 156 through the system connector 206. In these illustrative examples, the connection may be made by a cable 318.

The illustration of the setup for the aircraft flight data transmitter 118 is not meant to imply physical or architectural limitations the manner in which different setups may be made. For example, in some illustrative examples, additional or fewer satellite antennas may be present in the satellite antenna system 154.

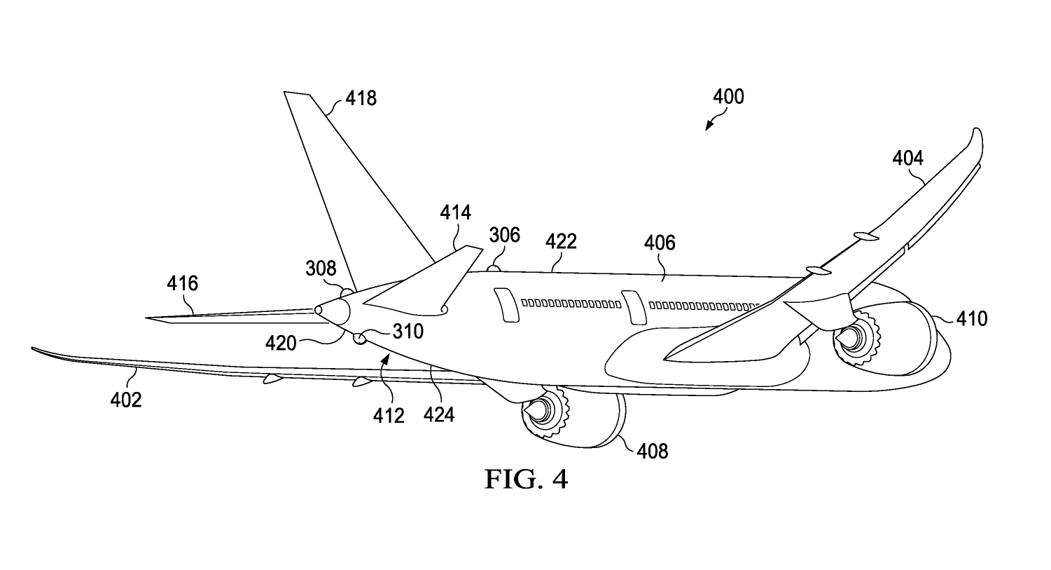

With reference to FIG. 4, a diagram of an aircraft is depicted in which an illustrative embodiment may be implemented. Aircraft 400 is an example of an implementation of the aircraft 102 in FIG. 1 in which the aircraft flight data transmitter 118 and the satellite antenna system 154 may be implemented.

In this illustrative example, the aircraft 400 has a first wing 402 and a second wing 404 attached to the body 406. The aircraft 400 includes a first engine 408 attached to the first wing 402 and a second engine 410 attached to the second wing 404. The body 406 has a tail section 412. A horizontal stabilizer 414, a horizontal stabilizer 416, and a vertical stabilizer 418 are present on the tail section 412.

As depicted, the aircraft flight data transmitter 118 may be in a location 420 inside the tail section 412 of the aircraft 400. In this illustrative example, the first satellite antenna 306 is located on the top side 422 of the body 406 of the aircraft 400. The second satellite antenna 308 is located on the top side 422 of the body 406 of the aircraft 400. The third satellite antenna 310 is located on the bottom side 424 of the body 406 of the aircraft 400.

Of course, these satellite antennas may be placed in other locations on the aircraft, depending on the particular implementation. Also, more or less satellite antennas also may be used. For example, addition satellite antennas may be placed on the sides of the body of the aircraft 400. Alternatively, the second satellite antenna 308 may be omitted in some illustrative examples.

The third satellite antenna 310 located on the bottom side 424 of the aircraft 400 is configured to transmit information, such as the collected data 136, even if the aircraft 400 is inverted in these illustrative examples.

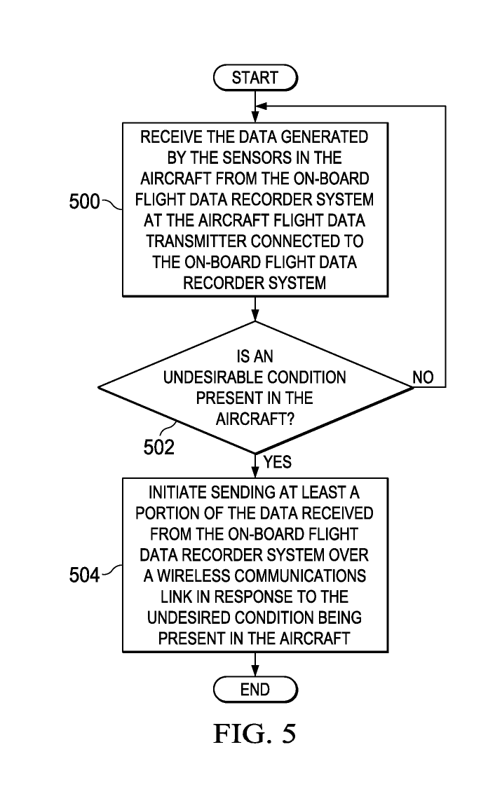

With reference now to FIG. 5, an illustration of a flowchart of a process for transmitting data 110 in FIG. 1 is depicted in accordance with an illustrative embodiment. The process illustrated in FIG. 5 may be implemented in the aircraft information environment 100 depicted in block form in FIG. 1.

The process begins by receiving the data 110 generated by the sensors 112 in the aircraft 102 from the on-board flight data recorder system 104 at the aircraft flight data transmitter 118 connected to the on-board flight data recorder system 104 (operation 500). The data 110 may be received from a number of the sensors 112 in these examples. A determination is made as to whether an undesired condition 142 is present in the aircraft 102 using the data 110 (operation 502).

If the undesired condition 142 is present, the process initiates sending at least a portion of the data 110 received from the on-board flight data recorder system 104 over a wireless communications link 144 in response to a determination that the undesired condition 142 is present in the aircraft 102 (operation 504). The portion of the data 110 may be selected as any portion from the data 110 received from the on-board flight data recorder system 104.

For example, the portion of the data 110 may be the collected data 136 for some number of seconds prior to the undesired condition 142 in the aircraft 102 and for some number of seconds after the undesired condition 142 in the aircraft 102 occurs. Different types of data 110 may be sent. For example, the collected voice data 140 in the collected data 136 stored from receiving the data 110 may be sent for some period of time prior to the undesired condition 142 occurring. The collected values of aircraft state parameters 138 stored in the aircraft flight data transmitter 118 from receiving the data 110 may be sent for some period of time before and after the undesired condition 142 occurs. With reference again to operation 502, if the undesired condition 142 is not present in the aircraft 102, the process returns to operation 500 to receive the data 110.

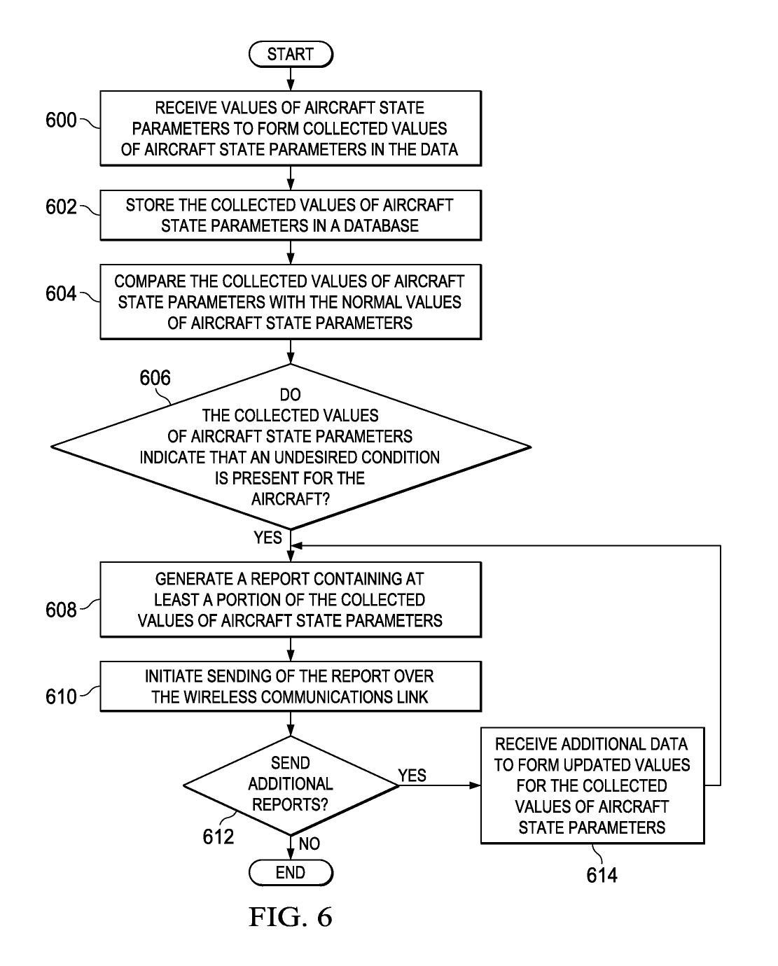

With reference now to FIG. 6, an illustration of a flowchart of a process for determining whether an undesired condition 142 is present in an aircraft 102 is depicted in accordance with an illustrative embodiment. The process illustrated in FIG. 6 may be implemented in the aircraft flight data transmitter 118 in FIG. 1. In particular, the process may be implemented using the state determination module 202 in the aircraft flight data transmitter 118 as illustrated in FIG. 2.

The process begins by receiving values of aircraft state parameters 114 to form collected values of aircraft state parameters 138 in the data 110 (operation 600). The process stores the collected values of aircraft state parameters 138 in a database 211 (operation 602).

The process then compares the collected values of aircraft state parameters 138 with the normal values of aircraft state parameters 216 (operation 604). A determination is made as to whether the collected values of aircraft state parameters 138 indicate that an undesired condition 142 is present for the aircraft 102 (operation 606).

If the collected values of aircraft state parameters 138 indicate that the undesired condition 142 is present, the process generates a report 222 containing at least a portion of the collected values of aircraft state parameters 138 (operation 608). This report 222 includes at least a portion of collected voice data 140 in the database 211.

The process then initiates sending of the report 222 over a wireless communications link 144 (operation 610). A determination is made as to whether to send additional reports 224 (operation 612). This determination may be made in a number of different ways. For example, the determination may be made based on whether the undesired condition 142 is still present. In other illustrative examples, this determination may be made based on whether a period of time has expired for sending additional reports 224. If a period of time has not expired, then the reporting continues.

In operation 612, if the report 222 are to be sent, the process receives additional data 110 to form updated values for the collected values of aircraft state parameters 138 (operation 614). The process then returns to operation 608. With reference again to operation 612, if the reporting is not to continue, the process terminates.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent a module, segment, function, and/or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams.

In some alternative implementations of an illustrative embodiment, the function or functions noted in the blocks may occur out of the order noted in the figures. For example, in some cases, two blocks shown in succession may be executed substantially concurrently or the blocks may sometimes be performed in the reverse order, depending upon the functionality involved. Also, other blocks may be added in addition to the illustrated blocks in a flowchart or block diagram.

For example, in some illustrative examples, the process illustrated in FIG. 6 may initiate the transmission of data using other communications systems in addition to the operations illustrated in FIG. 6. As another illustrative example, operation 612 may be omitted. In some cases, only a single report may be sent.

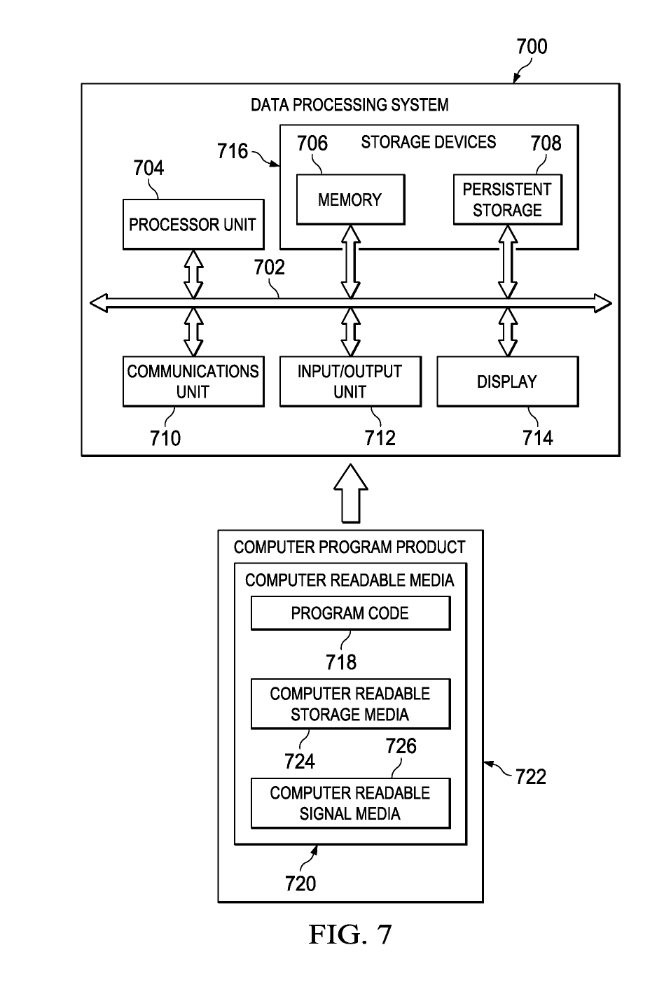

Turning now to FIG. 7, an illustration of a data processing system is depicted in accordance with an illustrative embodiment. The data processing system 700 may be used to implement components for an on-board flight data recorder system 104, an aircraft flight data transmitter 118, a state determination module 202, a communications module 204, and other suitable components. In this illustrative example, the data processing system 700 includes a communications framework 702, which provides communications between a processor unit 704, memory 706, a persistent storage 708, a communications unit 710, an input/output (I/O) unit 712, and a display 714. In this example, the communications framework 702 may take the form of a bus system.

The processor unit 704 serves to execute instructions for software that may be loaded into the memory 706. The processor unit 704 may be a number of processors, a multi-processor core, or some other type of processor, depending on the particular implementation.

The memory 706 and the persistent storage 708 are examples of storage devices 716. A storage device is any piece of hardware that is capable of storing information such as, for example, without limitation, data, program code in functional form, and other suitable information either on a temporary basis or a permanent basis. The storage devices 716 may also be referred to as computer readable storage devices in these illustrative examples. The memory 706, in these examples, may be, for example, a random access memory or any other suitable volatile or non-volatile storage device. The persistent storage 708 may take various forms, depending on the particular implementation.

For example, the persistent storage 708 may contain one or more components or devices. For example, the persistent storage 708 may be a hard drive, a flash memory, a rewritable optical disk, a rewritable magnetic tape, or some combination of the above. The media used by the persistent storage 708 also may be removable. For example, a removable hard drive may be used for the persistent storage 708.

The communications unit 710, in these illustrative examples, provides for communications with other data processing systems or devices. In these illustrative examples, the communications unit 710 is a network interface card.

The input/output unit 712 allows for input and output of data with other devices that may be connected to the data processing system 700. For example, the input/output unit 712 may provide a connection for user input through a keyboard, a mouse, and/or some other suitable input device. Further, the input/output unit 712 may send output to a printer. The display 714 provides a mechanism to display information to a user.

Instructions for the operating system, applications, and/or programs may be located in the storage devices 716, which are in communication with the processor unit 704 through the communications framework 702. The processes of the different embodiments may be performed by the processor unit 704 using computer-implemented instructions, which may be located in a memory, such as the memory 706.

These instructions are referred to as program code, computer usable program code, or computer readable program code that may be read and executed by a processor in the processor unit 704. The program code in the different embodiments may be embodied on different physical or computer readable storage media, such as the memory 706 or the persistent storage 708.

A program code 718 is located in a functional form on a computer readable media 720 that is selectively removable and may be loaded onto or transferred to the data processing system 700 for execution by the processor unit 704. The program code 718 and the computer readable media 720 form a computer program product 722 in these illustrative examples. In one example, the computer readable media 720 may be a computer readable storage media 724 or a computer readable signal media 726. In these illustrative examples, the computer readable storage media 724 is a physical or tangible storage device used to store the program code 718 rather than a medium that propagates or transmits the program code 718.

Alternatively, the program code 718 may be transferred to the data processing system 700 using the computer readable signal media 726. The computer readable signal media 726 may be, for example, a propagated data signal containing the program code 718. For example, the computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for the data processing system 700 are not meant to provide physical or architectural limitations to the manner in which different embodiments may be implemented. The different illustrative embodiments may be implemented in a data processing system including components in addition to and/or in place of those illustrated for the data processing system 700. Other components shown in FIG. 7 can be varied from the illustrative examples shown. The different embodiments may be implemented using any hardware device or system capable of running the program code 718.

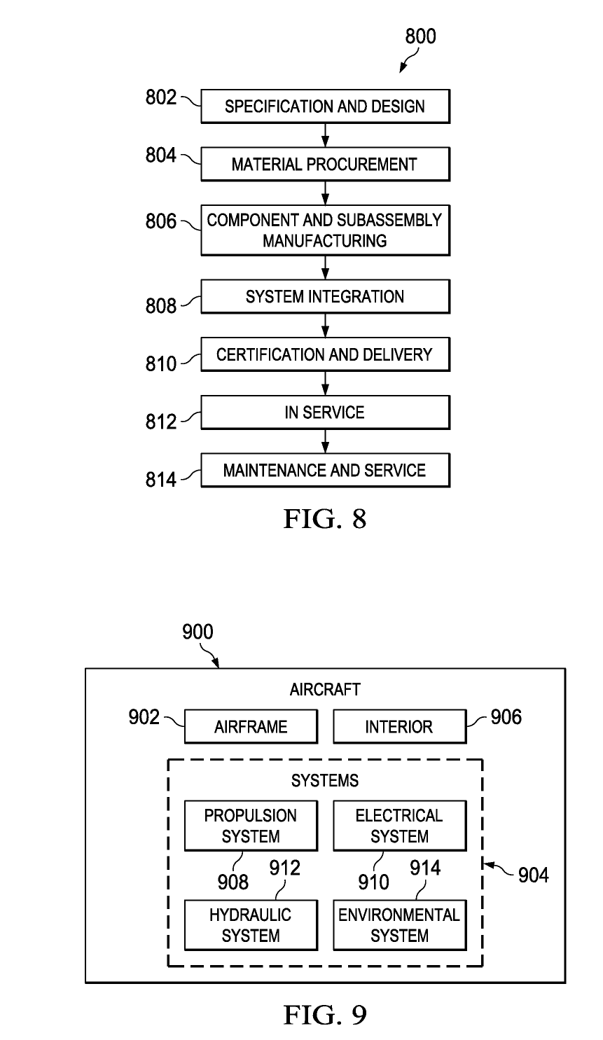

Illustrative embodiments of the disclosure may be described in the context of an aircraft manufacturing and service method 800 as shown in FIG. 8 and an aircraft 900 as shown in FIG. 9. Turning first to FIG. 8, an illustration of an aircraft manufacturing and service method is depicted in accordance with an illustrative embodiment. During pre-production, the aircraft manufacturing and service method 800 may include specification and design 802 of the aircraft 900 in FIG. 9 and material procurement 804.

During production, component and subassembly manufacturing 806 and system integration 808 of the aircraft 900 in FIG. 9 takes place. Thereafter, the aircraft 900 in FIG. 9 may go through certification and delivery 810 in order to be placed in service 812. While in service 812 by a customer, the aircraft 900 in FIG. 9 is scheduled for routine maintenance and service 814, which may include modification, reconfiguration, refurbishment, and other maintenance or service.

Each of the processes of the aircraft manufacturing and service method 800 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 9, an illustration of an aircraft is depicted in which an illustrative embodiment may be implemented. In this example, the aircraft 900 is produced by the aircraft manufacturing and service method 800 in FIG. 8 and may include an airframe 902 with plurality of systems 904 and an interior 906. Examples of the systems 904 include one or more of a propulsion system 908, an electrical system 910, a hydraulic system 912, and an environmental system 914. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 800 in FIG. 8. For example, the aircraft flight data transmitter 118 may be manufactured during the component and subassembly manufacturing 806 and implemented into the aircraft 900 during the system integration 808. Testing of the aircraft flight data transmitter 118 may occur during the certification and delivery 810. Further, the aircraft flight data transmitter 118 may be used while the aircraft 900 is in service 812. Further, the aircraft flight data transmitter 118 and the antenna system 152 may be added to the aircraft 900 during the maintenance and service 814. The aircraft flight data transmitter 118 and/or the antenna system 152 may be added as a modification, reconfiguration, refurbishment, or other maintenance for the aircraft 900. The use of a number of the different illustrative embodiments may substantially expedite the assembly of and/or reduce the cost of the aircraft 900.

Thus, the different illustrative embodiments provide a method and apparatus for transmitting the data 110 collected from the on-board flight data recorder system 104 in response a determination that the undesired condition 142 is present in the aircraft 102. In these illustrative examples, this transmission of the data 110 is more likely to occur because the aircraft flight data transmitter 118 is connected to the on-board flight data recorder system 104. In other words, the aircraft flight data transmitter 118 receives both the data 110 and the power 122 from the on-board flight data recorder system 104.

In this manner, additional wiring, changes, and modifications to the aircraft 102 are unnecessary if the aircraft flight data transmitter 118 is added as an upgrade or during refurbishment of the aircraft 102. For example, finding a data bus having a high enough priority if the power 122 cannot be supplied to all of the aircraft 102 may be avoided.

Instead, the use of an existing connector such as the connector 120 in the form of the test connector 126 for the on-board flight data recorder system 104 is employed. Further, the antenna system 152 selected for transmitting the collected values of aircraft state parameters 138 from the data 110 is configured to be powered from the aircraft flight data transmitter 118. In other words, the antenna system 152 is also powered through an indirect connection to the connector 120 for the on-board flight data recorder system 104 through the aircraft flight data transmitter 118.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. An aircraft data transmission system comprising:
an aircraft flight data transmitter configured to be connected to a connector for an on-board flight data recorder system for an aircraft, receive data generated by sensors in the aircraft from the on-board flight data recorder system, determine whether an undesired condition is present in the aircraft using the data, and initiate sending of at least a portion of the data received from the on-board flight data recorder system over a wireless communications link in response to a determination that the undesired condition is present in the aircraft.

2. The aircraft data transmission system of claim 1, wherein the aircraft flight data transmitter is further configured to receive power from the connector.

3. The aircraft data transmission system of claim 1, wherein the connector is a test connector for the on-board flight data recorder system.

4. The aircraft data transmission system of claim 1, wherein the on-board flight data recorder system is selected from at least one of a flight data recorder, a voice recorder, and a combined flight data and voice recorder.

5. The aircraft data transmission system of claim 1, wherein in being configured to receive the data generated by the sensors in the aircraft from the on-board flight data recorder system, the aircraft flight data transmitter is configured to receive values for aircraft state parameters collected from a number of sensors in the aircraft to form collected values of the aircraft state parameters.

6. The aircraft data transmission system of claim 5, wherein in being configured to determine whether the undesired condition is present in the aircraft using the data, the aircraft flight data transmitter is configured to determine whether the collected values of the aircraft state parameters indicate a normal operation or an anomalous operation of the aircraft.

7. The aircraft data transmission system of claim 1, wherein the at least the portion of the data comprises at least one of voice data and collected values of aircraft state parameters.

8. The aircraft data transmission system of claim 2 further comprising:
a battery system configured to provide the power to the aircraft flight data transmitter.

9. The aircraft data transmission system of claim 1, wherein the aircraft flight data transmitter comprises:
a state determination module configured to receive the data generated by the sensors in the aircraft from the on-board flight data recorder system, determine whether the undesired condition is present in the aircraft using the data, and initiate sending of the at least the portion of the data received from the on-board flight data recorder system over the wireless communications link in response to the determination that the undesired condition is present in the aircraft; and
a communications module configured to establish the wireless communications link through an antenna system and transmit the at least the portion of the data.

10. The aircraft data transmission system of claim 9, wherein the antenna system comprises a number of satellite antennas.

11. The aircraft data transmission system of claim 9, wherein the antenna system is powered by the aircraft flight data transmitter.

12. The aircraft data transmission system of claim 1, wherein the aircraft flight data transmitter is configured to store the at least the portion of the data received from the on-board flight data recorder system for the aircraft in a buffer in the aircraft flight data transmitter.

13. The aircraft data transmission system of claim 1, wherein the at least the portion of the data is sent from at least one of before detecting the undesired condition and after detecting the undesired condition, wherein the data is sent over the wireless communications link in response to the determination that the undesired condition is present in the aircraft.

14. The aircraft data transmission system of claim 1, wherein the aircraft flight data transmitter is connected to a primary power bus in power buses in the aircraft and the primary power bus has a highest priority in terms of power distribution in the power buses.

15. The aircraft data transmission system of claim 1, wherein the portion of the data includes information for identifying a trajectory of the aircraft.

16. A method for transmitting data, the method comprising:
receiving the data generated by sensors in an aircraft from an on-board flight data recorder system at an aircraft flight data transmitter connected to a connector for the on-board flight data recorder system;
determining whether an undesired condition is present in the aircraft using the data; and
initiating sending of at least a portion of the data received from the on-board flight data recorder system over a wireless communications link in response to a determination that the undesired condition is present in the aircraft.

17. The method of claim 16, wherein the step of initiating sending of the at least the portion of the data received from the on-board flight data recorder system over the wireless communications link in response to the determination that the undesired condition is present in the aircraft comprises:
initiating sending the portion of the data from at least one of before detecting the undesired condition and after detecting the undesired condition, wherein the data is sent over the wireless communications link in response to the determination that the undesired condition is present in the aircraft.

18. The method of claim 16, wherein the step of determining whether the undesired condition is present in the aircraft using the data comprises:
determining whether collected values of aircraft state parameters indicate a normal operation or an anomalous operation of the aircraft.

19. The method of claim 16, wherein the on-board flight data recorder system is selected from at least one of a flight data recorder, a voice recorder, and a combined flight data and voice recorder.

20. The method of claim 16, wherein the at least the portion of the data comprises at least one of voice data and collected values of aircraft state parameters.
